(19) United States
(12) Patent Application Publication
(10) Pub. No.: US 2007/0272685 A1
(43) Pub. Date: Nov. 29, 2007

(54) Quartz Glass Component For A Uv Radiation Source And Method For Producing And Testing The Aptitude Of Such A Quartz Glass Component

(76) Inventors: Andreas Schreiber, Birstein (DE); Bodo Kuehn, Gelnhausen (DE); Franz-Josef Schilling, Freigericht (DE); Erich Arnold, Mainz (DE); Hans-Dieter Witzke, Berlin (DE)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 11/578,393

(22) PCT Filed: Apr. 5, 2005
(86) PCT No.: PCT/EP05/03549

§ 371 Date: Oct. 13, 2006

(30) Foreign Application Priority Data
Apr. 15, 2004 (DE) 10 2004 018 887.4

(51) Int. Cl. H01J 61/38

(52) U.S. Cl. 220/2.1 R; 501/53; 65/17.3

(57) ABSTRACT

In a known method, a quartz glass component is produced for a UV radiation source by melting SiO₂-containing grain. Starting therefrom, to indicate an inexpensive method by means of which a quartz glass component is obtained that is characterized by high radiation resistance, it is suggested according to the invention that synthetically produced quartz crystals are molten to obtain a pre-product which consists of quartz glass containing hydroxyl groups in a number greater than the number of SiH groups, and that for the elimination of SiH groups the pre-product is subjected to an annealing treatment at a temperature of at least 850° C., whereby the quartz glass component is obtained. In the quartz glass component of the invention, the quartz glass is molten from synthetically produced quartz crystals, and it has a content of SiH groups of less than 5×10¹⁷ molecules/cm³.

The present invention relates to a component of quartz glass for a UV radiation source.

Furthermore, the present invention relates to a method for producing a quartz glass component for a UV radiation source, comprising the melting of SiO₂-containing grain.

Moreover, the present invention relates to a diagnosing method for diagnosing the suitability of a quartz glass component for use with a UV radiation source.

UV radiation sources are e.g. used for curing, modifying, coating and cleaning surfaces, for sterilizing gases, liquids, surfaces and packaging, for UV measuring technology, industrial photochemistry, drying and curing of printing inks, lacquers, adhesives and filling compounds, lacquer drying and analyzing technology.

UV radiation sources comprise a discharge space which is e.g. defined by an envelope in the form of a tube or bulb. Apart from low-pressure and medium-pressure gas discharge lamps which have been known for a long time, UV excimer lamps are increasingly used. Such a UV excimer lamp is described in EP 0 254 111 A1. The discharge space is filled with a noble gas or with a gas mixture and bounded by a quartz glass tube in which a quiet electric discharge is generated. High-power excimer lamps emit an almost monochromatic incoherent radiation. Typical operating wavelengths are 172 nm (Xe lamps), 222 nm (KrCl lamps), 282 nm (XeBr lamps) and 308 nm (XeCl lamps).

To achieve a high radiation intensity, an envelope is needed with a high UV transparency. Quartz glass of both natural and synthetic raw materials is in principle suited for this purpose on account of its UV transparency. Particular emphasis is however laid on the constancy of the UV power output during use of the UV lamp, especially for applications in the UV measuring and analyzing technology. It has been found that the high photon energy of the UV radiation in the quartz glass of the envelope generates defects in the glass structure (so-called “color centers”) which effect absorptions in specific wavelength ranges and thus changes in transmission. Such defects of the glass structure may also produce mechanical stresses in the quartz glass envelope, which may even lead to breakage of the enveloping tube. Problems with respect to defect generation are posed by the particularly high-energy photons of the 172 nm-Xe excimer lamp.

The various quartz glass qualities differ in their radiation resistance. In general, synthetically produced fused silica shows a higher radiation resistance to high-energy UV radiation than does quartz glass of natural raw materials. Synthetic fused silica is used for sophisticated applications as an enveloping material for UV lamps and for cover plates. However, the production of synthetic fused silica of high purity is complicated and the fused silica is thus expensive.

The UV radiation resistance of a quartz glass has so far been determined by way of irradiation tests. To this end samples taken from the quartz glass are prepared and exposed to UV radiation with the corresponding operating wavelength. The irradiation periods required for determining the radiation resistance may here last several months, depending on the specific irradiation conditions (energy density, wavelength, etc.).

It is therefore the object of the present invention to provide a quartz glass component of highly transparent, but relatively inexpensive quartz glass for a UV radiation source that is characterized by high radiation resistance.

It is further the object of the present invention to provide an inexpensive method for producing such a quartz glass component.

It is another object of the present invention to provide a diagnosing method by means of which the suitability of any quartz glass for use with high-energy UV radiation can be determined in a simple, reliable and inexpensive way.

As for the quartz glass component, this object is achieved according to the invention in that the quartz glass is molten from synthetically produced quartz crystals and has a content of SiH groups of less than 5×10¹⁷ molecules/cm³.

The radiation resistance of quartz glass is impaired by extrinsic and intrinsic defects.

The extrinsic defects include impurities. These are incorporated into the quartz glass via the raw material and via the manufacturing method, e.g. through crucible and furnace materials.

Intrinsic defects are structural defects of the quartz glass network that are produced through thermal influences during the manufacturing process. Many of these structural defects act as optical absorption or color centers in the UV and deep UV spectral range, or they form “precursor defects” from which other structural defects may arise due to irradiation with short-wave UV radiation. The defects or precursor defects explained in more detail in the following show absorption bands in the short-wave UV spectral range and must particularly be heeded:
an oxygen-excess defect in which a nonbridging oxygen atom is present (a so-called NBOH center); with a relatively broad absorption band at a wavelength of about 265 nm,
a defect in which only three (instead of four) oxygen atoms are bound to a silicon atom and which is designated as an E′ center; with an absorption band around 215 nm,
and a defect designated as an oxygen-deficient center in which a silicon-silicon bond is present that produces an absorption band at 163 nm.

Since formation and concentration of the extrinsic and intrinsic defects depend on both the raw materials and the manufacturing method, it makes sense to classify the different quartz glass qualities according to these criteria.

A suitable classification is found in “R. Bruckner, Silicon Dioxide; Encyclopedia of Applied Physics, Vol. 18 (1997), pp. 101-131”. Depending on the raw material and manufacturing method used, several quartz glass types must thus be distinguished:
Quartz glass type I is a quartz glass of electrically fused quartz crystals. Typically, said quartz glass has an OH content of less than 5 wt ppm and an impurity content of 10 to 100 wt ppm.
Quartz glass according to type II is formed by fusing quartz crystals in oxyhydrogen gas (H₂/O₂). Due to the manufacturing process said quartz glass has an increased OH content between 100 and 300 wt ppm.
Synthetic quartz glass is produced either by flame hydrolysis, by plasma-supported oxidation or by sol-gel methods (types III, IV and VII). Depending on the manufacturing process and the kind of treatment before vitrification, said quartz glass types have OH contents within a wide range of less than 0.1 ppm to about 1000 wt ppm and very low impurity contents.
Quartz glass type Va refers to quartz glass molten in an electrical melting process from pegmatitic quartz (quartz in combination with other minerals) in a crucible in a hydrogen-containing atmosphere. The resulting quartz glass typically has an OH content of 100 wt ppm and normally contains impurities of up to a few hundred wt ppm. However, the OH content can be reduced to a range of <1 ppm to 15 ppm by outgassing at a high temperature (10 hours at 1080° C.), resulting in quartz glass type Vb.
In connection with the present invention a further quartz glass type is of interest which is created by melting quartz crystals in a plasma flame. Due to the manufacturing process said quartz glass has a considerably lower OH content than quartz glass of type II and will be designated in the following as quartz glass of type VIII.

Quartz glass of type III and IIIa is synthetically produced quartz glass which although it is normally well suited for UV applications is expensive and thus not the subject of the present invention. Quartz glass of type V is normally used for standard applications in the field of lamp optics. Said quartz glass is molten in large amounts of several tons from natural pegmatitic quartz. By contrast, quartz glasses of types I and II are produced in small amounts and used for the semiconductor industry, for the chemical industry and also for lamps.

According to the invention a quartz glass component is suggested wherein the quartz glass is made from synthetically produced quartz crystals. This is a modification of the above-mentioned quartz glass types I, II and VIII insofar as the quartz crystals used are specified to be synthetically produced quartz crystals (also called “growth crystals” hereinafter). Quartz growth crystals are starting materials of a higher purity in comparison with natural quartz. Such synthetic quartz crystals are normally produced in a so-called “hydrothermal method”, which will explained in more detail further below. The quartz glass molten from quartz growth crystals is much cheaper than synthetic quartz glass.

It is also important that the quartz glass of the quartz glass component of the invention has a content of SiH groups that is as low as possible. Although SiH groups in quartz glass do not absorb in the relevant UV wavelength range, the bonds are relatively weak and, upon irradiation with short-wave UV light, they may easily break up (in a so-called “one-photon process”) with formation of absorbing E′ centers. E′ centers effect an increased absorption at a wavelength of 215 nm and are also unfavorably noticed in the adjoining UV wavelength range. Therefore, they have an adverse effect on the radiation resistance of the quartz glass component. SiH groups can increasingly be found in quartz glass if it has a high hydrogen content. The raw material which is here used, namely synthetic quartz crystals, may contain small amounts of hydrogen due to the manufacturing process; additional hydrogen may here be introduced through the manufacturing method into the quartz glass, as will be discussed in more detail further below with reference to the method of the invention.

In this respect the content of SiH groups in the quartz glass is as small as possible. Ideally, the content of SiH groups is less than 5×10¹⁶ molecules/cm³, which approximately corresponds to the present detection limit with the measuring method indicated further below.

It has turned out to be advantageous when the quartz glass has a content of hydroxyl groups of at least 25 wt ppm, preferably at least 100 wt ppm.

As is generally known, a certain amount of hydroxyl groups has an advantageous effect on the radiation resistance of quartz glass.

It has turned out to be particularly advantageous when the quartz glass is produced by melting synthetic quartz crystals by means of a burner flame.

This is a modification of the above-explained quartz glass type II according to Bruckner. Due to the use of a burner flame and, accompanied by this, a hydrogen-containing fuel which reacts with oxygen to form water, OH groups are incorporated to an enhanced degree into the quartz glass molten in this way. These groups can be used with the help of an annealing treatment for reducing the SiH groups which are also present therein, as will be explained in more detail further below with reference to the method of the invention.

The quartz glass component of the invention is e.g. present as a disk, tube or as a bulb. One embodiment of the quartz glass component of the invention wherein said component is formed as an envelope with a wall thickness in the range between 0.4 mm and 8 mm has turned out to be particularly useful.

The comparatively thin wall thickness effects a short diffusion path which facilitates the elimination of SiH groups from the quartz glass by means of an annealing treatment, which will be explained in more detail further below with reference to the method of the invention.

As for the method, the above-indicated object, starting from a method with the above-mentioned features, is achieved according to the invention in that synthetically produced quartz crystals are molten to obtain a pre-product which consists of quartz glass containing hydroxyl groups in a number greater than the number of SiH groups, and that for the elimination of SiH groups the pre-product is subjected to an annealing treatment at a temperature of at least 850° C., whereby the quartz glass component is obtained.

According to the invention a pre-product for the quartz glass component to be actually produced is prepared first by using a raw material in the form of synthetically produced quartz crystals.

Synthetic quartz crystals are starting materials of a purity higher than that of natural quartz, said starting materials being e.g. producible by means of the “hydrothermal method”. The quartz glass molten from synthetic quartz crystals is inexpensive in comparison with quartz glass produced by flame hydrolysis or plasma methods.

As a rule, the pre-product already shows the shape and dimensions of the quartz glass component proper. It is essential that the pre-product consists of quartz glass which contains SiH groups in a number smaller than the number of hydroxyl groups, as will be explained in more detail in the following.

The pre-product is subjected to an annealing treatment for eliminating SiH groups. SiH groups are firmly bonded to the glass network and do not diffuse or only diffuse to a small extent. They can therefore be removed from the quartz glass of the pre-product only by way of a reaction. Suitable reaction partners are hydroxyl groups (OH groups) which react with the SiH groups at high temperatures with formation of hydrogen which can diffuse out of the quartz glass of the pre-product. In this reaction one hydrogen molecule is formed according to the reaction equation
Si—H+Si—OH<-->Si—O—Si+H₂ (1)
from one SiH group and one SiOH group. An essential precondition for the efficiency of the annealing treatment is therefore that the number of the hydroxyl groups in the quartz glass of the pre-product is at least as large as the number of the SiH groups. The observation of this condition can particularly be influenced during melting of the synthetic quartz crystals. The content of hydroxyl groups in quartz glass is often indicated in the unit “wt ppm”. The conversion from this concentration unit into the number of hydroxyl groups per cm³ in the quartz glass is carried out by means of the factor: 7.8×10¹⁶ cm³/wt ppm.

In the annealing treatment which follows the melting process, the SiH groups are removed as much as possible from the quartz glass of the pre-product by reacting them with part of the OH groups which are present in excess so as to form reaction products that diffuse out of the quartz glass. On the one hand, it cannot be expected that the hydroxyl groups which are present in the quartz glass react one to one with the SiH groups within a short time so that a distinct excess of hydroxyl group is of help to a rapid and substantial elimination of the SiH groups and, on the other hand it is advantageous with respect to the radiation resistance of the quartz glass when also after the reaction of the OH groups with the SiH groups a residue of hydroxyl groups is contained in the quartz glass.

Therefore, a pre-product is preferably molten that consists of quartz glass containing hydroxyl groups in a number that is at least twice as large as the number of SiH groups.

It has turned out to be particularly useful when the annealing treatment takes place at a temperature in the range between 900° C. and 1200° C.

At temperatures below 900° C. there is only a small conversion of SiH groups and hydroxyl groups, and at temperatures above 1200° C. devitrification processes may take place. Moreover, the chemical balance of the above reaction (1) is shifted at high temperatures towards the left side, so that the formation of H₂ is slowed down and the removal of SiH groups will thus take longer.

The elimination of the SiH groups will be particularly efficient if the annealing treatment comprises a treatment in vacuum.

The vacuum effects a rapid discharge of the reaction products from the surface of the pre-product, thereby preventing a renewed reaction and accelerating the elimination of the SiH groups from the quartz glass. The vacuum is applied at least temporarily during the annealing treatment. As a supplement or alternative, it has turned out to be advantageous when the annealing treatment comprises a treatment in an oxygen-containing atmosphere.

Oxygen-deficient defects found in the quartz glass can be saturated by the oxygen present in the annealing atmosphere.

Preferably, the hydroxyl group content of the quartz glass is set to at least 25 wt ppm, preferably at least 100 wt ppm.

As has already been mentioned above with reference to the description of the quartz glass component of the invention, a certain amount of hydroxyl groups has an advantageous effect on the radiation resistance of quartz glass. The indicated minimum hydroxyl group content should therefore also be present in the finished quartz glass component after the annealing treatment and reaction with the SiH groups.

Preferably, the quartz glass component is formed as an envelope for the UV radiation source with a wall thickness ranging between 0.4 mm and 8 mm, the annealing temperature lasting for 4 hours to 80 hours, depending on the wall thickness.

The greater the wall thickness of the pre-product during the annealing treatment is, the longer will the diffusion process for the complete or substantial elimination of the SiH groups last. For economic reasons preference should therefore be given to a thin wall thickness of the pre-product. The envelope is e.g. a tube, a bulb, or a component shielding the UV radiation source, for instance a disk.

As for the diagnosing method the above-indicated object is achieved according to the invention in that the quartz glass component is exposed to excitation radiation and the fluorescence radiation of the quartz glass produced due to the excitation radiation is sensed in the wavelength range of 350 to 430 nm.

Surprisingly, it has been found that quartz glass shows little resistance to UV radiation and due to UV excitation radiation has a perceptible fluorescence in the visible blue wavelength range of 350 to 430 nm (e.g. at a wavelength of 390 nm). On the basis of this finding, which was checked and confirmed with different quartz glass qualities, the invention provides a diagnosing method by means of which the suitability of the quartz glass in question can be determined easily and reliably for an application with high-energy UV radiation.

It has turned out to be advantageous when the excitation radiation has a wavelength around 248 nm and when the fluorescence radiation of the quartz glass component is determined in a direction substantially perpendicular to the main propagation direction of the excitation radiation.

As a result, the measurement of the fluorescence radiation is hardly influenced by the excitation radiation.

The invention will now be explained in more detail with reference to embodiments and a drawing, in which

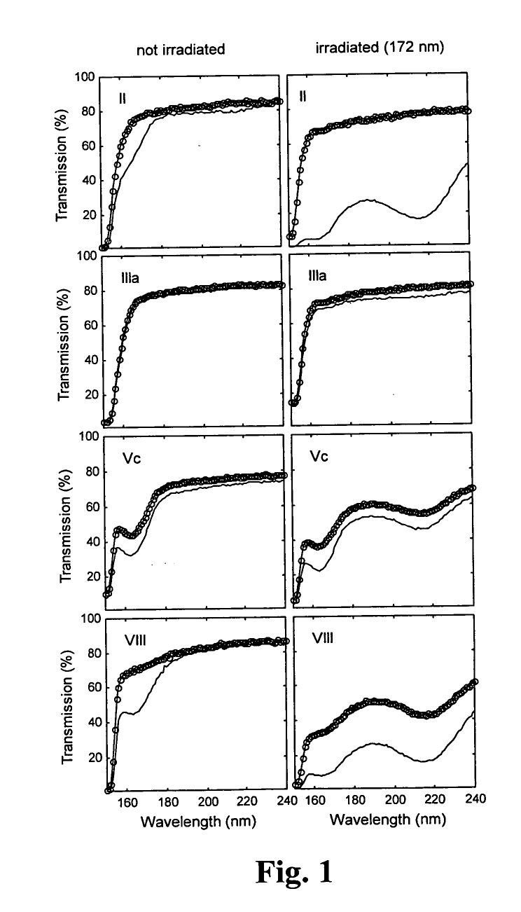

FIG. 1 shows UV transmission spectra of various quartz glass qualities and differently treated samples by way of comparison, and

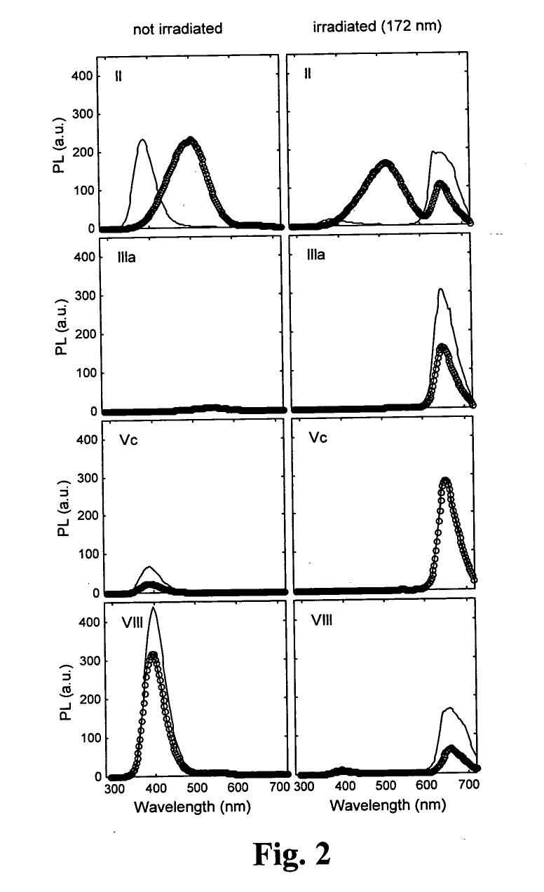

FIG. 2 shows fluorescence spectra of various quartz glass qualities and differently treated samples by way of comparison.

### PREPARATION OF QUARTZ-GLASS GROWTH CRYSTALS

The growth crystals for producing the quartz glass qualities according to types II and VIII (see FIG. 2) were produced according to the so-called “hydrothermal method”. In a vertically oriented autoclave, a pressure of 120 bar and a temperature gradient between 350° C. (upper portion) and 400° C. (lower portion) are generated. In the lower portion, broken quartz pieces are dissolved in a slightly alkaline solution. In the upper portion of the autoclave, quartz plates which have been cut in oriented fashion are arranged as seeds. Due to the temperature gradient from the bottom to the top, the quartz dissolved in the lower portion condenses on the quartz plates with formation of a synthetic quartz growth crystal. Such growth crystals are characterized by a higher purity in comparison with natural quartz crystals.

The following typical impurity contents are measured on growth crystals (data given in brackets in wt ppb): Li (550), Na (30), K (<20), Mg (<20), Ca (<30), Fe (100), Cu (<50), Ti (<10), and Al (8230).

Sample Preparation and Characterization

Quartz glass samples were produced from different quartz glass qualities. Quartz glass of type II and type VIII (see FIG. 1) was each time produced by using growth crystals, the growth crystals in the quartz glass of type II being molten by using a fuel gas flame (oxyhydrogen flame) and the quartz glass of type VIII by using a hydrogen-free plasma flame. The quartz glass of type IIIa is synthetically produced quartz glass which was obtained by means of flame hydrolysis of SiCl₄ according to the so-called soot method. The quartz glass of type Vc is quartz glass which was molten from synthetically produced quartz glass grain and had a hydroxyl group content of less than 25 wt ppm.

Before and after a thermal pretreatment, which will be described further below, the quartz glass samples were characterized by measuring their UV transmission in the wavelength range of 150 to 240 nm and by their SiH and hydroxyl group content.

The hydroxyl group content (OH content) becomes apparent from the measurement of the IR absorption according to the method of D. M. Dodd et al. (“Optical Determinations of OH in Fused Silica”, (1966), p. 3911).

The content of SiH groups is determined by means of Raman spectroscopy, a calibration being carried out on the basis of a chemical reaction. Si—O—Si+H2→Si—H+Si—OH, as described in Shelby “Reaction of hydrogen with hydroxyl-free vitreous silica” (J. Appl. Phys., Vol. 51, No. 5 (may 1980), pp. 2589-2593).

Thermal Pretreatment

One sample each of each pair of samples was thermally pretreated prior to UV radiation, which will be explained in more detail further below. To this end the sample was annealed at a temperature of 1050° C. and for a period of time of 40 hours in vacuum (10⁻² mbar).

The contents of hydroxyl groups and SiH groups before and after the annealing treatment (and prior to UV radiation) are specified in Table 1:

TABLE 1

| | | OH content | OH content | SiH content |
|---|---|---|---|---|
| Type | ΔT | [wt ppm] | [1/cm³] | [1/cm³] |
| II | No | 172 | 1.2 × 10¹⁹ | 3.0 × 10¹⁸ |
| II | Yes | 136 | | <5.0 × 10¹⁶ |
| IIIa | No | 201 | 2.2 × 10¹⁹ | <5.0 × 10¹⁶ |
| IIIa | Yes | 192 | | <5.0 × 10¹⁶ |
| Vc | No | 10.4 | 8.1 × 10¹⁷ | 5.0 × 10¹⁷ |
| Vc | Yes | 4.3 | | 1.0 × 10¹⁷ |
| VIII | No | 4.8 | 3.7 × 10¹⁷ | 1.0 × 10¹⁸ |
| VIII | Yes | 2.2 | | 8.0 × 10¹⁷ |

ΔT = annealing treatment
Conversion factor for the data on the OH contents between column 3 and 4: 7.8 × 10¹⁶ [number/cm³]

UV Irradiation Tests

For the UV radiation tests two disk-like samples were cut from each material with a wall thickness between 1 and 2 mm and optically polished and then irradiated with a xenon excimer lamp (excimer lamp 172/330 Z of Heraeus Noblelight, Hanau). This excimer lamp emits incoherent radiation with a maximum of the emission wavelength around 172 nm (half the bandwidth of the emission band is about 15 nm). For irradiation the samples were directly placed on the lamp enveloping tube. The irradiation intensity in the area of the samples was estimated to be about 160 mW/cm².

The irradiation period was 950 hours for the quartz glass types II, IIIa and VIII and 1590 hours for quartz glass type Vc.

Measurement of the Fluorescence

In addition, the fluorescence spectra upon irradiation with an excimer laser of a wavelength of 248 nm and a pulse width of 20 ns and of an energy density of 200 mJ/cm² were determined on all samples.

The fluorescence radiation was determined in a direction perpendicular to the main propagation direction of the excitation radiation, the spectra shown in FIG. 2 being obtained by integration for a period of time of 50 μs, starting with 10 μs after the excitation radiation had been switched on.

Results

FIG. 1 shows the transmission spectra of the various quartz glass samples (annealed and not annealed) before and after UV irradiation in the wavelength range between 150 nm and 240 nm. The “Bruckner type” of quartz glass samples II, IIIa, Vc, and VIII, the production of which has been explained in more detail above, is indicated in the diagram with Roman numerals.

In FIG. 1, each of the diagrams in the right column shows the transmission spectra of the irradiated samples and each of the diagrams at the left side those of the non-irradiated samples. In the diagrams, two measurement curves are each time plotted, of which the one where the measurement points are illustrated as circles shows the curve of the transmission in thermally pretreated samples, and the other one illustrated as an unbroken line symbolizes thermally non-pretreated samples.

It can basically be learnt from the spectra that all of the non-irradiated samples have a UV transmission ranging from average to good, but absorption bands arise in the range between 150 nm and 160 nm. With the exception of the synthetically produced quartz glass (IIIa), all of the samples show an absorption band at about 163 nm, which are typical of oxygen-deficient centers. Said absorption bands are relatively weak in the quartz glass of type II, which has not been treated thermally.

Due to the thermal treatment of the samples the transmission changes, and the 163-nm band, in particular, is reduced in all cases. This effect is very distinct in the quartz glasses of types II and VIII, which were made from growth crystals. The transmission of the thermally pretreated quartz glass of type II is close to the maximum to be expected in theory, especially also up to low wavelengths around 150 nm.

The diagrams at the right side of FIG. 1 show the transmission spectra after irradiation with 172-nm UV radiation. The irradiation with the UV excimer lamp leads in all samples to a reduction of the transmission (right column), particularly pronounced in quartz glass types II and VII, and hardly noticeable in the quartz glass type IIIa.

The quartz glass of type IIIa is substantially resistant to such radiation and, neither in the annealed nor in the non-annealed quality, shows any differences in transmission.

In the non-annealed quartz glass types II, VC and VII (unbroken lines), the absorption at 163 nm is enhanced by irradiation, and an absorption band which is due to E′ centers is formed at 215 nm. The longer the irradiation duration is, the stronger are the absorption bands at 163 nm and 215 nm, respectively. Moreover, after an irradiation duration of about 1,000 hours in quartz glass type Vc and after about 1,500 hours in type VIII fine cracks are found in the samples.

Although the annealing treatment effects an improved transmission and above all an improved UV radiation resistance also in quartz glass types Vc and VIII, the radiation resistance of quartz glass VIII is much lower than that of the quartz glass of type II. This may be due to the fact that the quartz glass of type VIII was obtained through water-free plasma melting of growth crystals, and thus showed a low hydroxyl group content already before the annealing process. As shown in Table 1, the number of hydroxyl groups before the annealing treatment is lower than the number of SiH groups, so that in this quartz glass the effect of the annealing treatment is reduced with respect to the elimination of SiH groups.

Although in the quartz glass of type Vc the number of the hydroxyl groups of the pre-product before the annealing treatment is slightly higher than the number of SiH groups, this is not enough for a complete elimination, as shown by the still measurable content of 1.0×10¹⁷ after the annealing treatment. Although the radiation resistance of this quartz glass is therefore slightly better than that of the quartz glass of type VI II, it is considerably worse than that of type II after the annealing treatment.

The improvement of the transmission and of the radiation resistance is particularly pronounced in quartz glass type II. Although the non-annealed quartz glass sample of type II is similarly degenerated by UV irradiation as the quartz glass qualities Vc and VIII, the annealed quartz glass sample II is resistant to UV radiation and shows no absorption bands at 163 nm and 215 nm. This quartz glass does also not show any crack formation after an irradiation period of 2,000 hours.

This can be explained by the fact that the quartz glass of type II has a small number of intrinsic and extrinsic defects. On the one hand, it is made from a comparatively pure starting material, namely from quartz growth crystals, so that it contains hardly any impurities. On the other hand, the production of the quartz glass by flame melting leads to a comparatively high hydroxyl group content (in comparison with plasma melting), which in turn—in the subsequent annealing treatment—permits a reduction of the SiH groups introduced by the production process to a value below the detection limit.

Checking the Radiation Resistance

FIG. 2 shows fluorescence spectra for quartz glass types II, IIIa, Vc and VIII in the wavelength range between 300 nm and 700 nm before and after irradiation with 172-nm UV excimer radiation. To this end the fluorescence “PL” is plotted in relative units versus the wavelength in the range between 300 nm and 700 nm.

As can be seen, with the exception of the quartz glass of type IIIa, all samples show a blue fluorescence band at a wavelength of about 390 nm (unbroken line) before the thermal treatment. The thermal treatment of quartz glass types Vc and VIII hardly changes this blue fluorescence (line with measurement points in the form of circles).

By contrast, the fluorescence band in the flame-molten quartz glass of type II is erased by the thermal treatment. Instead of this, a fluorescence band appears in the green wavelength range (approximately at a wavelength of 510 nm). This change in the fluorescence spectra in quartz glass type II is a sign of a significant change in the SiO₂ network structure and it correlates with the above-described improvement of the UV radiation resistance of this quartz glass.

The quartz glass of type IIIa shows a weak fluorescence band in the green range substantially independently of a thermal pretreatment of said quartz glass.

The conclusion can be drawn from this result that a quartz glass sample showing a blue fluorescence band at 390 nm forms oxygen-deficient centers and E′ defect centers upon irradiation with UV excimer radiation of a wavelength of 172 nm, and the transmission in this wavelength range thereby decreases considerably (within the first 100 hours). By contrast, when the blue fluorescence band can be eliminated by annealing, the quartz glass is made radiation-resistant to 172 nm radiation, and the formation of oxygen defects or E′ defect centers is no longer observed. When blue fluorescence is not observed (as with type IIIa), the corresponding quartz glass material is resistant to UV irradiation independently of a thermal pre-treatment.

1. A quartz glass component for a UV radiation source, wherein quartz glass is formed by being molten from synthetically produced quartz crystals, said quartz glass having a content of SiH groups of less than 5×10¹⁷ molecules/cm³.

2. The quartz glass component according to claim 1, wherein the quartz glass has a content of hydroxyl groups of at least 25 wt ppm.

3. The quartz glass component according to claim 1, wherein the quartz glass has a content of SiH groups of less than 5×10¹⁶ molecules/cm³.

4. The quartz glass component according to claim 1, wherein the quartz glass is produced by melting the synthetically-produced quartz crystals by means of a burner flame.

5. The quartz glass component according to claim 1, wherein the quartz glass component is configured as an envelope with a wall thickness ranging from 0.4 mm to 8 mm.

6. A method for producing a quartz glass component, said method comprising:
melting SiO₂-containing grain, wherein synthetically produced quartz crystals are molten to obtain a pre-product comprising quartz glass containing hydroxyl groups in a number greater than a number of SiH groups therein; and
subjecting the pre-product to an annealing treatment at a temperature of at least 850° C., so as to eliminate some of the SiH groups and to produce the quartz glass component.

7. The method according to claim 6, wherein the number of hydroxyl groups in the quartz glass of the preproduct is at least twice as large as the number of SiH groups.

8. The method according to claim 6, wherein the annealing treatment is carried out at a temperature ranging between 900° C. and 1200° C.

9. The method according to claim 6, wherein the annealing treatment includes a treatment in a vacuum.

10. The method according to claim 6, wherein the annealing treatment includes a treatment in an oxygen-containing atmosphere.

11. The method according to claim 6, wherein the hydroxyl group content of the quartz glass is at least 25 wt ppm.

12. The method according to claim 6, wherein the quartz glass component is formed as an envelope for a UV radiation source with a wall thickness ranging between 0.4 mm and 8 mm, and the annealing treatment lasts between 4 hours and 80 hours, depending on the wall thickness.

13. The method according to claim 6, wherein due to the annealing treatment sets a content of SiH groups of less than 5×10¹⁷ molecules/cm³ in the quartz glass.

14. A method for diagnosing the suitability of a quartz glass component for use with a UV radiation source, said method comprising:
exposing the quartz glass component to an excitation radiation; and sensing the fluorescence radiation of the quartz glass component produced due to exposing the quartz glass component to the excitation radiation in the wavelength range of 350 nm to 430 nm.

15. The method according to claim 14, wherein the excitation radiation has a wavelength of about 248 nm.

16. The method according to claim 14, wherein the fluorescence radiation of the quartz glass component is determined in a direction that is substantially perpendicular to a main propagation direction of the excitation radiation.

17. The method according to claim 6, wherein the hydroxyl group content of the quartz glass is set to at least 100 wt ppm.

18. The method according to claim 6, wherein the annealing treatment sets a content of SiH groups of less than 5×10¹⁶ molecules/cm³ in the quartz glass.

19. The quartz glass component according to claim 1, wherein the quartz glass has a content of hydroxyl groups of at least 100 wt ppm.
